(19) United States
(12) Patent Application Publication
(10) Pub. No.: US 2012/0236573 A1
(43) Pub. Date: Sep. 20, 2012

(54) LIGHTING APPARATUS

(76) Inventors: Shoji Yamamoto, Osaka-shi (JP); Hideyuki Akao, Osaka-shi (JP)

(21) Appl. No.: 13/514,126

(22) PCT Filed: Oct. 18, 2010
(86) PCT No.: PCT/JP2010/068269

§ 371 Date: Jun. 6, 2012

(30) Foreign Application Priority Data
Dec. 7, 2009 (JP) 2099-277804

(51) Int. Cl. F21V 11/00

(52) U.S. Cl. 362/311.02; 362/311.01

(57) ABSTRACT

A lighting apparatus includes LEDs and a light-permeable cover passing the light emitted from the LEDs and an anti-scattering film is arranged on the cover for preventing the scattering of fragments when the cover fractures. The anti-scattering film contains a dispersing agent for dispersing light. Since the anti-scattering film containing a dispersing agent is arranged on the cover, when the lighting apparatus is damaged by falling, the scattering of fragments of the cover is preventable, and the glare can be reduced because the light emitted from the LEDs are dispersed through the dispersing agent contained in the anti-scattering film. Since the anti-scattering film containing the dispersing agent is arranged on the cover, the deterioration of luminance flux is preventable as compared to a case of arranging on the cover a member for anti-scattering and a member for reducing glare separately.

This application is the national phase under 35 U. S. C. §371 of PCT International Application No. PCT/JP2010/068269 which has an International filing date of Oct. 18, 2010 and designated the United States of America, all of which are hereby expressly incorporated by reference into the present application.

BACKGROUND

1. Technical Field

The present invention relates to a lighting apparatus including a light source and a light-permeable cover passing light emitted from the light source.

2. Description of Related Art

A lighting apparatus, which is used for illumination of indoor and outdoor, has a light source and a light-permeable cover allowing light to pass, arranged at the light-emitting direction of the light source. When a lighting apparatus in which a light-emitting diode (hereinafter referred as LED) is used as a lighting source, more particularly, since the light source has long operating life, a cover made of glass without long-term deterioration has been in use.

However, a glass is prone to be fractured by an impact such as falling. Conventionally, with respect to a lighting apparatus using a member such as glass being prone to be fractured, several measures for preventing the scattering of fractures when the member is fractured have been proposed (for example, see Japanese Utility Model Application Laid-Open No. 7-41847).

In the glass-made illumination device disclosed in Japanese Utility Model Application Laid-Open No. 7-41847, a transparent-rubber resilient body or a soft resin film is formed on the outer surface and/or inner surface of the glass-made illumination device. Therefore, when the glass-made illumination device is fractured by damage, the prevention of the scattering of glass fragments and the improvement in safety can be performed since the transparent-rubber resilient body or the soft resin film is stretched.

### SUMMARY

When a light source having strong optical directivity, such as an LED, is used, a user is likely to feel uncomfortable by dazzlement (also known as glare). Therefore, it is common to arrange a diffusion plate, a diffusion film or the like for dispersing light in the light-emitting direction relative to the light source in a lighting apparatus having a light source with strong optical directivity.

When a lighting apparatus utilizes a light source such as an LED with longer durability and strong optical directivity, it is preferable to provide both measures of preventing the scattering of the cover and reducing glare to the cover of the light source. However, when both measures of preventing scattering and reducing glare are provided by forming the transparent-rubber resilient body or the soft resin film to prevent the scattering of the cover and separately arranging a member for dispersing light from the light source, a problem occurs that respective members absorb the light from a light source and luminance flux is deteriorated.

The present invention has been made in view of such circumstances. It is an object to provide a lighting apparatus having an anti-scattering film which can prevent the scattering of fragments when the cover fractures and reduce glare without deteriorating luminance flux.

A lighting apparatus according to the present invention is a lighting apparatus which includes a light source and a light-permeable cover passing light emitted from the light source, and in which an anti-scattering film is arranged on the cover for preventing the scattering of fragments when the cover fractures, wherein the anti-scattering film contains a dispersing agent for dispersing light.

In the present invention, the anti-scattering film preventing the scattering of fragments when the cover fractures is arranged on the cover passing light emitted from the light source, and the anti-scattering film contains the dispersing agent for dispersing light. Since the anti-scattering film containing the dispersing agent is arranged on the cover, the scattering of fragments of the cover can be prevented when the lighting apparatus is damaged by falling, and the glare can be reduced because light emitted from the light source is dispersed through the dispersing agent in the anti-scattering film. Since the anti-scattering film containing the dispersing agent is arranged on the cover, the deterioration of luminance flux can be prevented as compared to a case of arranging on the cover a member for anti-scattering of fragments when the cover fractures and a member for reducing glare of the light source separately.

According to the lighting apparatus of the present invention, the anti-scattering film is arranged on an inner surface of the cover.

In the present invention, the anti-scattering film is arranged on the inner surface of the cover, so it is possible to reduce an adhesion of dirt to the anti-scattering film and a detachment of the anti-scattering film and continue effects of the anti-scattering of fragments when the cover fractures and the reduction of glare of the light source.

According to the lighting apparatus of the present invention, the anti-scattering film contains silicone rubber.

In the present invention, the anti-scattering film contains silicone rubber. Even if the lighting apparatus is damaged by falling or the like, the anti-scattering film containing silicone rubber with elasticity absorbs the damage by falling or the like, so the scattering of fragments of the cover can be prevented. And, since silicone rubber is unlikely to generate color change due to long-term deterioration, it is possible to use for a long term without change of parts.

According to the lighting apparatus of the present invention, the light source is an LED.

In the present invention, the LED is used as the light source. The light emitted from the LED as the light source with strong optical directivity is dispersed through the dispersing agent in the anti-scattering film, so the glare can be reduced.

According to the present invention, it is possible to prevent the scattering of fragments when the cover fractures and reduce glare without deteriorating luminance flux.

The above and further objects and features will more fully be apparent from the following detailed description with accompanying drawings.

### BRIEF DESCRIPTION OF THE SEVERAL VIEWS OF THE DRAWINGS

FIG. 1 is a schematic external view of a lighting apparatus according to a first embodiment of the present invention.

FIG. 2 is a schematic exploded perspective view of the lighting apparatus according to the first embodiment.

FIG. 3 is a schematic longitudinal sectional view of the lighting apparatus according to the first embodiment.

FIG. 4 is a schematic plan view of an essential part of the lighting apparatus according to the first embodiment.

FIG. 5 is a schematic enlarged sectional view of a part of a cover utilized in the first embodiment.

FIG. 6 is a view showing an example of arrangement of LEDs.

FIG. 7 is a schematic plan view of an essential part of a lighting apparatus according to a second embodiment of the present invention.

FIG. 8 is a schematic sectional view of a radiator of a lighting apparatus according to a third embodiment of the present invention.

FIG. 9 is a schematic plan view of an essential part of the lighting apparatus according to the third embodiment.

### DETAILED DESCRIPTION

The present invention will be described below in detail as an example of a bulb-type lighting apparatus based on drawings illustrating embodiments of the present invention.

### First Embodiment

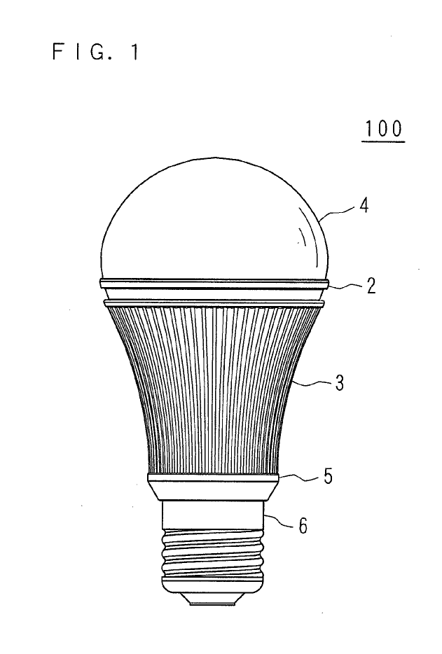

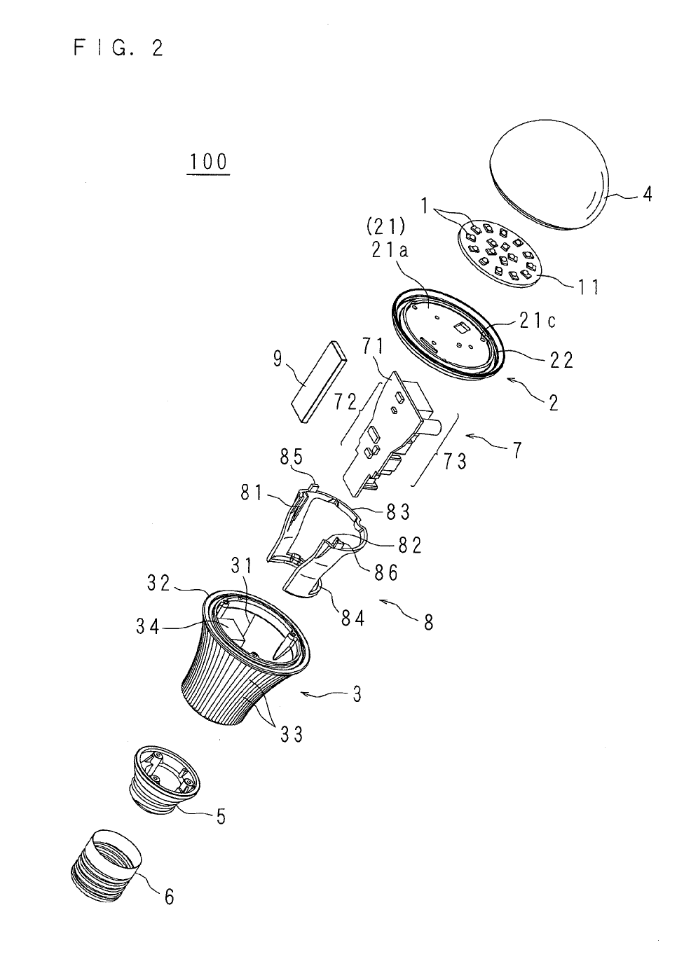

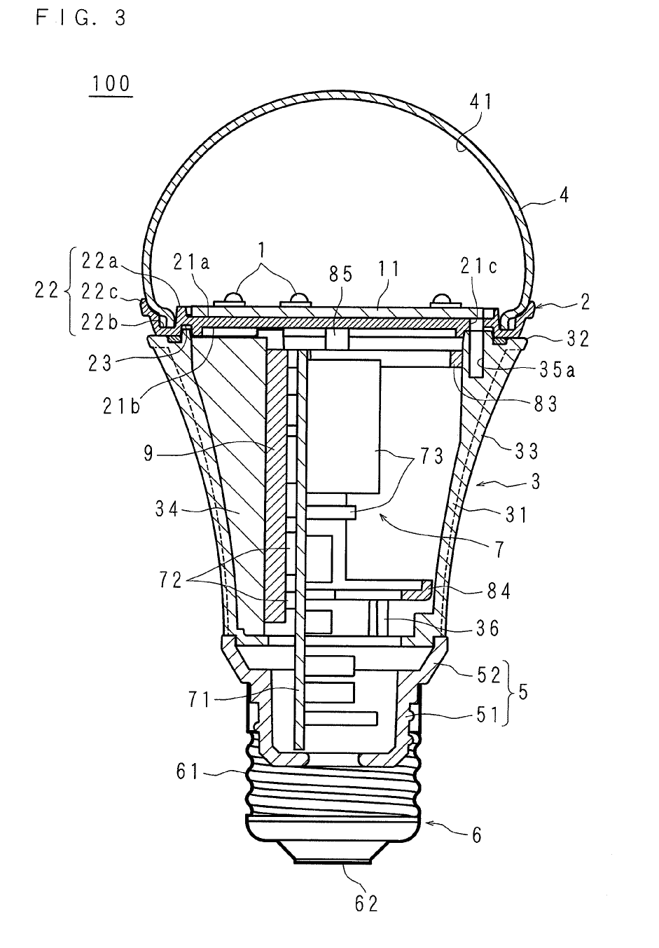

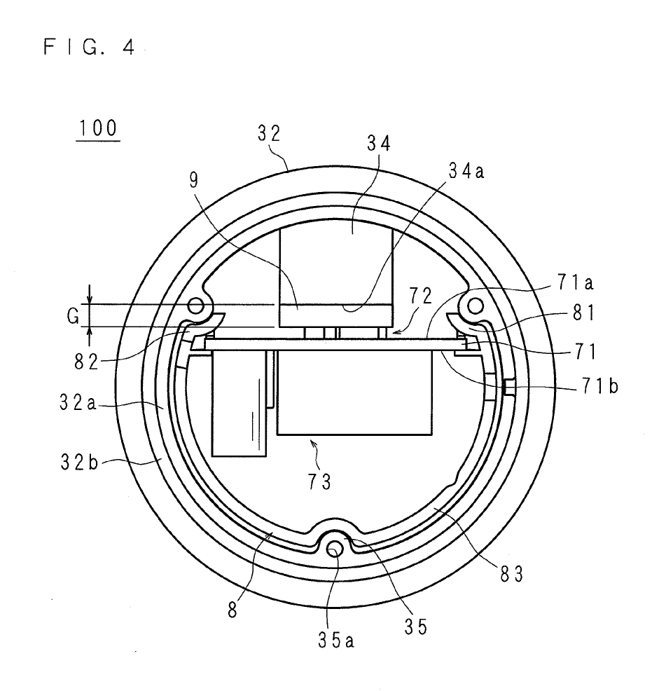

FIG. 1 is a schematic external view of a lighting apparatus 100 according to the first embodiment of the present invention. FIG. 2 is a schematic exploded perspective view of the lighting apparatus 100 according to the first embodiment. FIG. 3 is a schematic longitudinal sectional view of the lighting apparatus 100 according to the first embodiment. FIG. 4 is a schematic view of an essential part of the lighting apparatus 100 according to the first embodiment.

In the drawings, the numeral 1 is an LED is utilized as a light source. The LED 1 is a surface mount type LED including, for example, an LED element, a sealing resin which seals the LED element and in which a fluorescent substance is scattered, an input terminal and an output terminal. A plurality of LEDs 1 are mounted on one side of a mounting board 11, which is in the form of a disk.

The mounting board 11 on which LEDs 1, 1 . . . are mounted is fixed upon a heat sink 2 at the other side as the non-mounting side. The heat sink 2 is made of a metal such as aluminum. The heat sink 2 includes a circular fixed plate portion 21, and the mounting board 11 is fixed on one side 21a of the circular fixed plate portion 21. At the periphery of the side 21a of the fixed plate portion 21, an attaching portion 22 is provided to be attached to a cover mentioned below. The attaching portion 22 includes a round-shaped ridge 22a arranged with protruding at the outer periphery of the side 21a of the fixed plate portion 21, a round-shaped concave portion 22b arranged in series with the ridge 22a and concentric with the fixed plate portion 21, and a round-shaped convex portion 22c arranged in series with the concave portion 22b with protruding in the same direction as the ridge 22a. Additionally, a plane at the protrusive side of the convex portion 22c is tilted in such a manner that the height of the protrusion increases from the inside to the outside corresponding to the shape of the cover.

An engagement groove 23 engaging with an after-mentioned radiator is arranged at the periphery of the other side 21b of the fixed plate portion 21 of the heat sink 2. Additionally, a plurality of threaded screw holes 21c, 21c, . . . are arranged at the periphery of the fixed plate portion 21. Also, it is preferable to interpose a thermal conducting sheet and grease with good thermal conduction between the mounting board 11 and the heat sink 2. The heat sink 2 is attached to a radiator 3 at the other side 21b.

The radiator 3, which is made of metal such as aluminum, includes a radiation cylinder 31 with cylindrical shape. The diameter of the radiation cylinder 31 gradually increases from one end side to one other end side in longitudinal direction, and a flange portion 32 is arranged at the other end side of the radiation cylinder 31. An engagement convex portion 32a engaging with the engagement groove 23 is arranged on the inner periphery of one side of the flange portion 32. A ring-shaped concave portion 32b, which is concentric with the radiation cylinder 31, is formed on the one side of the flange portion 32.

On the circumferential surface of the radiation cylinder 31, a plurality of fins 33, 33, . . . , which protrude outwardly in the radial direction, are distributed equally in the circumferential direction along the longitudinal direction of the radiation cylinder 31. Respective ends of the longitudinal direction of the plurality of fins 33 are arranged in series with the flange portion 32 of the radiator 3.

The radiation cylinder 31 includes a protruding portion 34 protruded radially inward direction from a part of the inner circumferential surface of the radiation cylinder 31. The protruding portion 34 is made of metal such as aluminum and formed over a suitable length in longitudinal direction of the radiation cylinder 31. The protruding portion 34 has a rectangular shape from the cross-section view as shown in FIG. 4. A protruding edge face 34a of the protruding portion 34 is roughly parallel to a power circuit board of an after-mentioned power supply section, and it is formed on the plane facing the center line of the radiation cylinder 31. At the protruding edge face 34a, the power supply section is connected thermally to the radiator 3, and the protruding portion 34 functions as a thermal conducting section for conducting the heat produced by the power supply section to the radiator. Moreover, the protruding portion 34 may be integrated into the radiation cylinder 31. Alternatively, the protruding portion 34 may be formed separately from the radiation cylinder 31 as arranging the protruding portion 34 on the radiation cylinder 31 by utilizing an adhesive agent.

A plurality of boss portions 35 having threaded screw holes 35a are provided inside the flange portion 32 of the radiator cylinder 31. The heat sink 2 is attached to the radiator 3 by tightening with screws at the state of mounting the heat sink 2 on the flange portion 32 with integrating threaded holes 21c, 21c, . . . , 35a, 35a, . . . . Thus, the mounting board 11 on which the LEDs 1, 1, . . . are mounted is fixed on the radiator 3 through the heat sink 2. Additionally, a waterproof packing is fitted into the concave portion 32b of the flange portion 32 of the radiator 3, therefore, the heat sink 2 can be brought into close contact with the flange portion 32, and a water drop entering into the interior is preventable. An after-mentioned power supply section is housed inside the radiator 3.

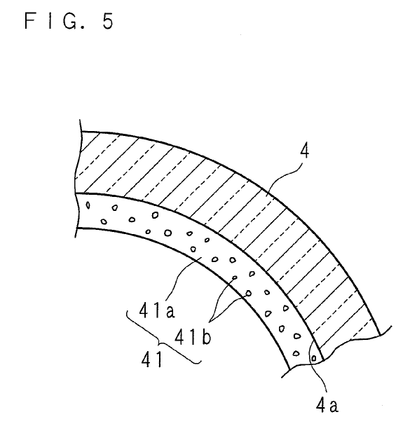

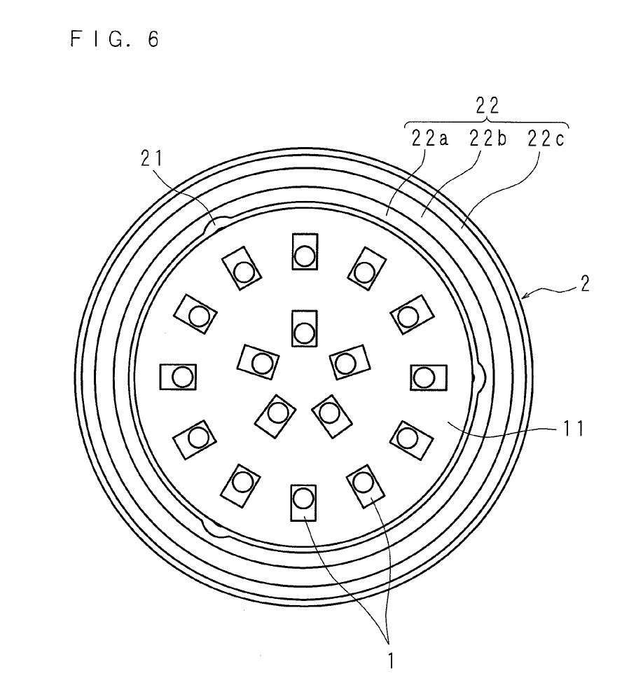

The light-permeable cover 4 is attached to the flange portion 32 of the radiator 3 in order to cover the side of light-emitting direction originated from the LEDs 1, 1 . . . . The cover 4 is made of a milky-white glass having a hemispherical enclosure. FIG. 5 is a schematic enlarged sectional view of a part of the cover 4 utilized in the present invention. FIG. 6 is a view showing an example of an arrangement of the LEDs 1, 1 . . . .

An anti-scattering film 41 is arranged on the roughly entire region in the inner surface 4a of the cover 4 for preventing the scattering of fragments when the cover 4 fractures. The anti-scattering film 41 is formed by applying and solidifying a coating material produced by the addition of a dispersing agent 41b for dispersing light to a resin-made film base material 41a containing silicone rubber. It is preferred that the dispersing agent 41b, for example, has a crystalline structure and possesses larger diffraction ratio, smaller light absorption capability, and higher scattering power as the optical properties. For example, barium titanate, titanium oxide, aluminum oxide, silicon oxide, calcium carbonate, or the like are utilized as dispersing agents. A fluorescent substance may be added to the film base material 41a in addition to the dispersing agent 41b or instead of the dispersing agent 41b. As the fluorescent substance, yttrium is used. Additionally, according to the present embodiment, the film thickness of the anti-scattering film 41a is approximately 30 (μm). Moreover, according to the present embodiment, a silicone rubber is utilized as the base material film 41a. The other material, which is stretchable without any fracture and has elasticity or ductility in order that fragments are not scattered when the cover 4 fractures, may be utilized as the base material film 41a.

Regarding a method of forming the anti-scattering film 41 having the dispersing agent 41b on the cover 4 as described above, the dispersing agent 41b may be added and mixed with the resin-made film base material 41a containing silicone rubber and then the mixed coating material is coated on the inner surface of the cover 4 and then solidified; alternatively, a coating material of the resin-made film base material 41a containing silicone rubber and a coating material containing the dispersing agent 41b may be coated separately on the inner surface of the cover 4 and then solidified. In this alternative method, a film layer of the coating material of the resin-made film base material 41a containing silicone rubber and a film layer of the coating material containing the dispersing agent 41b may be overlapped.

The cover 4, which is constructed by the above-mentioned step, is attached to the concave portion 22b of the heat sink 2 at the periphery of the aperture side. According to this configuration, the lights, which are emitted from LEDs 1, 1, . . . arranged as shown in FIG. 6, enter into the anti-scattering film 41 arranged on the inner surface of the cover 4, and the incident lights pass through the cover 4 while scattered by the dispersing agent 41b inside the anti-scattering film 41, then exit to the exterior from the cover 4. Regarding this simple configuration, the light distribution originated from the LEDs 1, 1, . . . as the light sources with strong optical directivity can be broadened. When the fluorescent substance is added to the anti-scattering film 41, since the fluorescent substance causes the light to disperse and the fluorescent substance is excited by the light and then radiates light, the light distribution can further be broadened.

A base 6 is arranged through a connection body 5 at the opposite side of the flange portion 32 of the radiation cylinder 31 of the radiator 3. The connection body 5 is in bottomed cylindrical shape and includes a base holding part 51 for holding the base 6 and a connecting part 52 provided to the base holding part 51 in a link manner and connected to the radiator 3. The base holding part 51 has an aperture for an electric wire at the bottom. At the circumferential surface of the base holding part 51, the threading is performed for screwing with the base 6. The base holding part 51 and the connecting part 52 are made of, for example, an insulator material such as a resin, and formed in a body. The connection body 5 is integrated into the radiator 3 by utilizing a screw to fix the side of the connecting part 52 in a state of being conformed and aligned with a threaded hole at the opposite side of the flange portion 32 of the radiation cylinder 31 of the radiator 3.

The base 6 is in bottomed cylindrical shape and includes one pole terminal 61 of which the cylindrical portion is performed by screw processing for screwing with a light bulb socket and the other pole terminal 62 protruded at the bottom of the base 6. The outer shape of cylindrical portion of the base 6 is formed as the same shape of, for example, an E17 or E26 screwed cap. The base 6 is integrated into the connection body 5 by inserting the base holding part 51 of the connection body 5 into the base 6 and screwing it.

The cavity, which is formed through the integration of the heat sink 2, the radiator 3 and the connection body 5, houses a power supply section 7 for supplying a power with predetermined voltage and current to the LEDs 1, 1, . . . through wires and a holding body 8 for holding the power supply section 7 inside the cavity.

The power supply section 7 includes a power circuit board 71 having a shape corresponding to the sectional shape of the cavity for housing it and a plurality of circuit components mounted on the power circuit board 71. Thermal radiation components 72 are mounted on one-side face 71a of the power circuit board 71 as circuit components. The amount of thermal radiation produced by the supplied current of the thermal radiation components 72 is higher than that of the circuit components 73 mounted on the other-side face 71b. The thermal radiation components 72 include a bridge diode performing a full-wave rectification on AC current supplied from an external AC power supply, a transformer transforming power supply voltage after rectification into a predetermined voltage, a diode connected to the first winding and second winding of the transformer, IC or the like. In addition, for example, a glass epoxy board and a paper phenol substrate may be utilized as the power circuit board 71.

The holding body 8 holding the power supply section 7 is made of a material having an insulating property such as a resin, and it forms in a shape which can be inserted inside the radiation cylinder 31. The holding body 8 includes clamping portions 81, 82 for clamping the power circuit board 71 of the power supply section 7, semi-circular frames 83, 84 having smaller shape than the inner diameter of the radiation cylinder 31 and arranged at the side of the base 6 and the heat sink 2, and protrusions 85, 86 installed on the frame 83 at the side of the heat sink 2 in a protruding manner toward the other side 21b of the heat sink 2. The clamping portions 81, 82 include contact pieces for contacting the boss portion 35 of the radiation cylinder 31 and opposing pieces opposing the contact pieces with having a space which is roughly similar to the thickness of the power circuit board 71, and the power circuit board 71 is clamped between the contact pieces and the opposing pieces.

The holding body 8 is inserted inside the radiation cylinder 31 of the radiator 3 from the side of the frame 84, and the contact pieces of the clamping portions 81, 82 make contact with the boss portion 35 of the radiation cylinder 31; therefore, the locating guide of the holding body 8 relative to the circumferential direction of the radiation cylinder 31 can be done. Additionally, the locating guide of the holding body 8 relative to the longitudinal direction of the radiator cylinder 31 can be done by a support convex portion 36 arranged at a side of one end (the side of the base 6) of the radiation cylinder 31 of the radiator 3 and supporting the holding body 8 at the frame 84, and by the protrusions 85, 86 arranged at the side of the heat sink 2.

By inserting and placing the holding body 8 inside the radiator 3, the power supply section 7 is installed inside the connection body 5, in such a manner that the power circuit board 71 is roughly parallel to the protruding edge face 34a of the protruding portion 34 and the thermal radiation components 72 mounted on one-side face 71a of the power circuit board 71 come close to the protruding edge face 34a. Regarding the installation condition according to the present embodiment, the space between the one-side face 71a of the power circuit board 71 and the protruding edge face 34a of the protruding portion 34 is about 5 (mm), and the space G between the circuit components mounted on the one-side face 71a of the power circuit board 71 and the protruding edge face 34a is about 3 (mm). A thermal conducting sheet 9 in the form of a rectangular plate is interposed between the one-side face 71a of the power circuit board 71 and the protruding edge face 34a. The appropriate dimension and locating position of the heat conducting sheet 9 is determined by an arrangement of thermal radiation components 72.

The power supply section 7 is electrically connected to the one pole terminal 61 and the other pole terminal 62 of the base 6 through an electric wire (not shown). Additionally, the power supply section 7 is electrically connected to the LEDs 1, 1 . . . by connectors through electric wires. In stead of utilizing a wire, a pin plug may be used to make an electrical connection.

The lighting apparatus 100, configured as mentioned above, is connected to an external alternative power supply by screwing the base 6 with a light bulb socket. In this condition, as the power is being supplied, AC current is supplied to the power supply section 7 through the base 6. The power supply section 7 supplies the power with a predetermined voltage and current to the LEDs 1, 1, . . . and lights up the LEDs 1, 1, . . . . The lights, emitted from the LEDs as the light source with strong optical directivity, enter into the anti-scattering film 41 arranged on the inner surface of the cover 4, and the incident lights are passing through while being scattered by the dispersing agent 41b included in the anti-scattering film 41, and then the lights exit to the exterior from the cover 4. The light distribution originated from the LEDs 1, 1, . . . can be broadened and glare can be reduced by setting the simple configuration of arranging on the cover 4 the anti-scattering film 41 added by the dispersing agent 4b. Since the anti-scattering film 41 is mounted on the cover 4, the scattering of fragments of the cover 4 is preventable when the lighting apparatus 100 receives damage such as falling. In other words, the lighting apparatus 100 according to the present invention can prevent the scattering of a cover and reduce the glare of a light source by setting the simple configuration of arranging the anti-scattering film 41 having the dispersing agent 41b on the cover 4.

Additionally, by arranging the anti-scattering film 41 on the inner surface 4a of the cover 4, an adhesion of the dust scattering in the air or the like to the anti-scattering film 41 can be reduced and a detachment of the anti-scattering film 41 from the cover 4 is preventable. Accordingly, in the lighting apparatus utilizing an LED with longer durability as the light source, the effects of preventing the scattering of the cover and the reduction of glare of the light source can be lasted for a longer duration.

Further, compared to a cover made of a resin such as polycarbonate, the cover 4 made of glass is more likely to generate discoloration due to ageing. Accordingly, as described above, by arranging the anti-scattering film 41 having a dispersing agent on the glass-made cover 4, it is possible to use in a long duration the lighting apparatus 100 in which deterioration of luminance flux due to discoloration is small, while preventing the scattering of the cover at an occurrence of a damage such as falling to ensure the user's safety and keeping the state of reducing glare. Since discoloration due to aging is difficult to appear on the silicone rubber, which is utilized in the anti-scattering film 41, the deterioration of luminance flux due to discoloration of an anti-scattering film itself is preventable in a long duration.

In the lighting apparatus 100, the LEDs 1, 1, . . . and the thermal radiation components 72 of the power supply section 7 mainly generate heat along with lighting of LEDs 1, 1, . . . . The heat generated from LEDs 1, 1, . . . is conducted to the heat sink 2 and the radiator 3 and then scattered in the air of the external of the lighting apparatus 100 from the heat sink 2 and the radiator 3. On the other hand, the heat generated from the thermal radiation components 72 of the power supply section 7 is mainly conducted to the radiator 3 and scattered in the air of the external of the lighting apparatus 100 from the radiator 3.

In the lighting apparatus 100 according to the present embodiment, the protruding portion 34 is formed with protruding inward radially from a part of the inner surface of the radiation cylinder 31 of the radiator 3, and the thermal radiation components 72 such as bridge diode, transformer, diode, IC or the like are arranged intensively on the one-side face 71a of the power circuit board 71, the power supply section 7 is arranged inside the radiator 3 so as to make the thermal radiation components 72 close to the protruding portion 34. As a result, the space between the thermal radiation components 72 and the radiator 3 becomes smaller so that the heat generated from the thermal radiation components 72 can be conducted to the radiator 3 effectively, and then the conducted heat can be scattered to the air through fins 33, 33, . . . of the radiator 3. As a result, the efficiency of heat radiation of the lighting apparatus 100 can be improved. Moreover, since the thermal conducting sheet 9 is interposed, the efficiency of heat radiation can further be improved.

### Second Embodiment

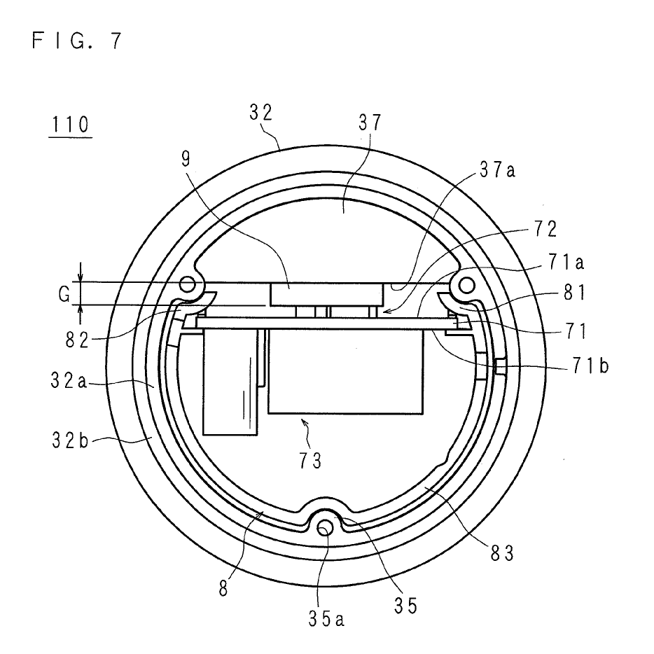

FIG. 7 is a schematic plan view of an essential part of a lighting apparatus 110 according to the second embodiment of the present invention. In the lighting apparatus 100 according to the first embodiment, the protruding portion 34 protruded in a radially inward direction from a part of the radiation cylinder 31 is formed in the radiation cylinder 31 of the radiator 3; however, in stead of the protruding portion 34, in the present embodiment, an opposite portion 37 having a plane face 37a roughly parallel to the power circuit board 71 of the power supply section 7 and facing to the power circuit board 71 is formed in the radiation cylinder 31. The opposite portion 37 is made of metal such as aluminum, and it is formed in a suitable length along the longitudinal direction of the radiation cylinder 31. The cross section of the opposite portion 37 is in a half-moon shape as shown in FIG. 7. The power supply section 7 is thermally connected to the plane face 37a of the opposite portion 37. The opposite portion 37 functions as a thermal conducting section for conducting heat from a power supply section to a radiator. Additionally, the opposite portion 37 may be integrated into the radiation cylinder 31. Alternatively, the opposite portion 37 may be formed separately from the radiation cylinder 31 and the opposite portion 37 may be fixed to the radiation cylinder 31 by an adhesive agent or the like. Since other configurations are similar to the first embodiment shown in FIG. 4, the similar reference numbers are appended to the corresponding configuration members in FIG. 4 so the detailed description of the configuration is omitted. Additionally, the schematic cross-sectional shape of the lighting apparatus 110 is similar to the schematic cross-sectional shape of the lighting apparatus 100 shown in FIG. 3.

In the lighting apparatus 110 configured as mentioned above, since the power supply section 7 is arranged inside the radiator 3 so as to make the thermal radiation components 72 close to the opposite portion 37 formed in the radiator 3, the space between the thermal radiation components 72 and the radiator 3 can be smaller so that the efficiency of thermal radiation of the lighting apparatus 110 can be improved as well as the lighting apparatus 100 of the first embodiment.

### Third Embodiment

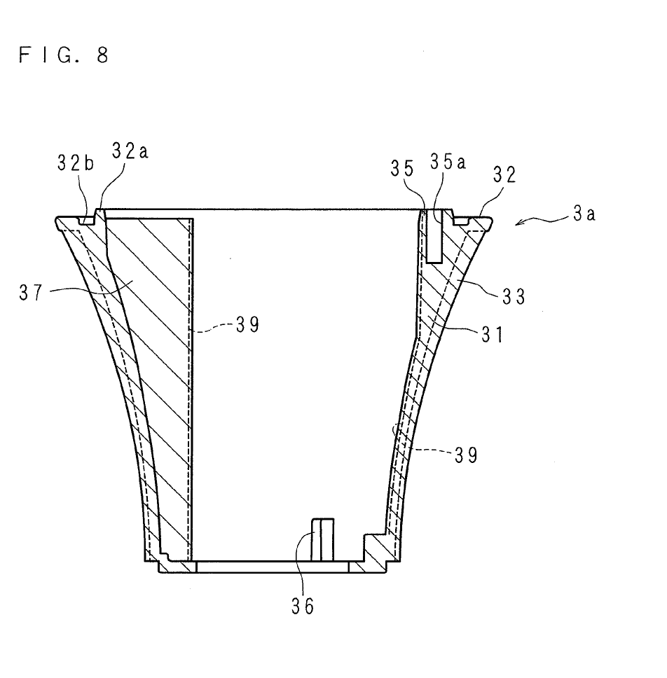

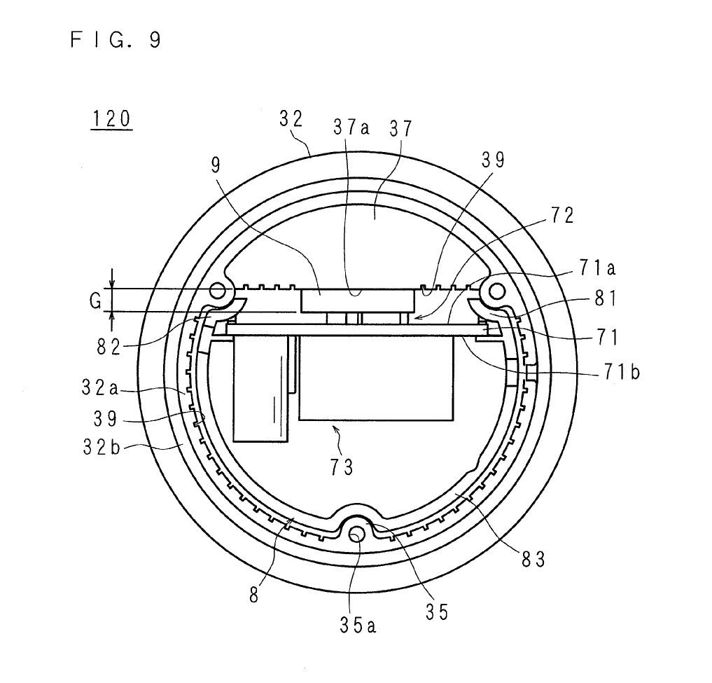

FIG. 8 is a schematic sectional view of a radiator of a lighting apparatus 120 according to the third embodiment of the present invention. FIG. 9 is a schematic plane view of an essential part of the lighting apparatus 120 according to the third embodiment. In the present embodiment, the refinement of heat absorption is devised to the radiator 3 of the lighting apparatus 110 of the second embodiment. Specifically, regarding the lighting apparatus 120, on the inner surface of a radiator 3a including a plane face 37a of the opposite portion 37, a plurality of grooves 39 whose cross-sectional shapes are U-shaped forms are formed with distributed evenly over the circumferential direction and extending throughout the entire length along the longitudinal direction of the radiator 3a. Since the surface area contacting the air inside the radiator 3a becomes larger, the surface area absorbing the internal air with increasing temperature due to the thermal radiation of the power supply section 7 becomes larger.

Furthermore, the black coating material is coated on the inner surface of the radiator 3a including the plane face 37a of the opposite portion 37 so that it is possible to absorb inside the radiator the heat generated from the power supply with great efficiency; therefore, it is possible to improve the efficiency of thermal radiation of the radiator. A coating material with high UV light absorption efficiency is utilized as the coating material in the present embodiment. For example, a coating material containing carbon is suitably utilized. Even if referring to the first and second embodiments, the similar effect can also be obtained by coating a black coating material on the protruding portion 34, or on the opposite portion 37, or on the inner surface of the radiator 3a.

Since other configurations are similar to the second embodiment shown in FIG. 7, the similar reference numbers are appended to the corresponding configuration members in FIG. 7 so the detailed description of the configuration is omitted.

Regarding the lighting apparatus 120 configured as mentioned above, the plurality of grooves 39 are arranged on the inner surface of the radiation cylinder 31 of the radiator 3a. As described above, since the area of contact surface between the radiation cylinder 31 and the air medium, which is warmed by the heat generated from the power supply section 7, becomes larger so that it is able to conduct the heat from the power supply section 7 to the radiator 3a with great efficiency through the internal air; therefore, the efficiency of thermal radiation of the lighting apparatus 120 can be improved. Additionally, since a black coating material is coated on the inner surface of the radiation cylinder 31, the thermal conduction carried out by radiation becomes more efficient so that the thermal radiation of the lighting apparatus 120 can further be improved.

According to the present embodiment, although the grooves 39 whose cross-sectional shapes are U-shaped forms are arranged throughout the entire length along the longitudinal direction of the radiator 3a, the shape of the groove 39 is not limited. A groove may be arranged so as to increase the surface area of the radiator 3a. For example, grooves whose cross-sectional shapes are wedge-shaped forms may be arranged, or grooves may be arranged along the circumferential direction of the radiator 3a.

The power supply section 7 as the heat source housed in the cavity formed by the integration of the heat sink, the radiator and the connection body included in the lighting apparatus is only described in the above-mentioned embodiment; however, in a lighting apparatus with a lighting control function for adjusting quantity of light and/or chromaticity of light of LED, a control section for lighting control may also be treated as a heat source. In this case, regarding the similar configuration including the power circuit board 71 in the above-mentioned embodiment, it is able to conduct the heat from the control section to the radiator with great efficiency by arranging a control circuit board to the proximity of a part of the radiator.

Regarding the mentioned-above embodiments, the cover 4 is made of glass; however, a material for making the cover is not limited to glass. The cover made of a material such as rigid resin that is damaged easily may be applicable. Since the aged-deterioration appears less on the glass as compared to resin such as polycarbonate resin generally utilized as a cover, it is preferable to utilize glass as a cover of a light source such as an LED with longer durability. By coating an anti-scattering film containing a dispersing agent on the cover as described in the present invention, it is possible to prevent the scattering of a cover and reduce glare without deteriorating luminance flux even if the fragile glass is utilized.

Regarding the above-mentioned embodiments, the anti-scattering film 41 is arranged on the cover 4 by coating a coating material; however, by adhering a film-shaped anti-scattering film instead of coating material, an anti-scattering film may also be arranged on the cover.

Regarding the above-mentioned embodiments, the anti-scattering film 41 is arranged on the inner surface 4a of the cover 4; however, even by arranging the anti-scattering film 41 on the outer surface of the cover 4, it is able to prevent the scattering of the cover and reduce the glare.

Regarding the above-mentioned embodiments, an LED is utilized as a light source; however, utilizing an LED is not the only option. In the present invention, a lighting apparatus including a light source with strong optical directivity may be suitably applicable.

Furthermore, regarding the above-mentioned embodiments, a light-bulb type lighting apparatus mounted on a socket for a light bulb is described; however, it is not limited to this type of the lighting apparatus. Other types of lighting apparatuses may also be applicable. The scope of matter described in claims can be practiced by other modified modes.

The present invention is applicable to a lighting apparatus including a light source and a light-permeable cover for passing light emitted from the light source.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1.-4. (canceled)

5. A lighting apparatus, comprising:
a light source;
a light-permeable cover passing light emitted from the light source; and
an anti-scattering film arranged on the cover for preventing the scattering of fragments when the cover fractures;
wherein the anti-scattering film contains a dispersing agent for dispersing light.

6. The lighting apparatus according to claim 5,
wherein the anti-scattering film is arranged on an inner surface of the cover.

7. The lighting apparatus according to claim 5,
wherein the anti-scattering film contains silicone rubber.

8. The lighting apparatus according to claim 5,
wherein the light source is an LED.
